(19) United States
(12) Patent Application Publication
(10) Pub. No.: US 2012/0013468 A1
(43) Pub. Date: Jan. 19, 2012

(54) WIRELESS OBJECT LOCALIZATION AND REGISTRATION SYSTEM AND METHOD

(76) Inventor: George OLAH, Ottawa (CA)

(21) Appl. No.: 13/182,894

(22) Filed: Jul. 14, 2011

Related U.S. Application Data
(60) Provisional application No. 61/364,919, filed on Jul. 16, 2010.

(51) Int. Cl. G08B 13/14

(52) U.S. Cl. 340/572.1

(57) ABSTRACT

A system for the accurate determination of the position of an article and the location of lost articles through wireless ranging. Provision is made for positional exception monitoring, as well as the centralized tracking of the whereabouts of articles.

### CROSS-REFERENCE TO RELATED APPLICATIONS

This application claims priority from U.S. Provisional Patent Application No. 61/364,919 filed Jul. 16, 2010.

### BACKGROUND OF THE INVENTION

1. Technical Field

The present disclosure relates generally to the locating and tracking of objects through accurate wireless position determination, and more specifically, to the locating and tracking of objects fitted with active wireless transceiver tags.

2. Description of the Prior Art

Over time, many systems have been proposed for the tracking and/or location of objects by ultrasonic or radio frequency wireless communication.

In one type of system, exemplified by U.S. Pat. No. 6,462,658, to Bender, object location is provisioned by attaching or incorporating into the article to be tracked an electronic module consisting of a radio frequency receiver unit and a visual or auditory annunciator. According to this object tracking model, the receiver module is programmed to decode and respond to a specifically designated identification code. The tracked object's owner may then make use of a dedicated radio transmitter to send an activation message containing the designated code to the object's associated receiver unit. Upon receipt of the correct activation code, the tracked object's receiver will then flash or emit a customized sound, allowing the object itself to be identified and located. In another aspect of the Bender system, the transmitter unit may be configured to continually re-transmit a radio frequency signal, and the object-affixed receiver designed to flash or emit a warning sound should the signal not be received, to alert to an out-of-range condition.

U.S. Pat. No. 7,135,968, to Hosny, diclosesa mechanism for keeping track of an electronically tagged object and correlating such an object to a specific owner. According to this system, a portable article, for example a piece of luggage, is fitted with a small electronic device which incorporates a small ultrasonic transmitter. The transmitter periodically emits a Frequency Shift Keying encoded signal which includes a unique binary address specifically assigned to the tracked article. The system operator or owner of the tagged object is provided with a complimentary ultrasonic receiver/demodulator device, which monitors the object transmitter's address broadcasts, verifying the correct digital address. The receiver may thus alert the system operator or owner should the object's transmissions cease to be copied, and thus warn of an object out-of-range condition.

Another type of article tracking system is disclosed in U.S. Pat. No. 6,883,710 to Chung, wherein a series of wireless receiving stations are distributed around a tracking region or facility. The receiving stations are equipped with antenna arrays which are sensitive to tracking signals within their physical domain of tagged object registration responsibility. In this system, the objects to be tracked are fitted with “smart tags”, which are composed of an electronic memory containing application-specific information about the tracked article, as well as an antenna and radio frequency transmission system for the broadcasting of the object's application-specific information. As the tagged object moves through the region or facility, the various wireless receiving stations receive and decode the information broadcasts, allowing the location of the object to be correlated to specific receivers. The receiver stations are coupled together by a digital data communications network, allowing them to pass object location information between themselves, and providing for control and monitoring of the stations themselves.

An objective is the provision of a flexible, simply operated, and easily deployed system that provides object registration, tracking, and location monitoring, while also allowing for the rapid and facile location of an object that has escaped tracking, has become lost, or intentionally separated from the group. For example, an object can be left behind at a location for later tracking.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

According to one aspect, a first digital radio frequency transceiver module is provided, comprising at least one antenna, a transmitter and receiver block, and a deterministic microprocessor. For the purposes of this specification, the term “deterministic” means that the processor's operation and behaviour is entirely predictable with respect to time, given a specific instruction or sequence of instructions to be executed from a known processor starting state. Such processors are commonly employed in hard real time applications, when the minimum and maximum latency of a given computational operation must be strictly controlled.

In a second aspect, the first transceiver module may emit a uniquely identified digitally encoded “probe” record or packet on a pre-defined radio frequency range, which may then be received by a second, equivalent digital transceiver module, which in turn may then emit an “echo” packet for reception by the first module.

Upon reception of the echo packet, the first module may mark the total time elapsed from initial probe packet transmission to echo packet reception, and after correction for packet processing and turnaround times within the two modules, compute the total radio propagation delay between the modules, allowing the inter-modular distance to be calculated by time-of-flight ranging.

In a third aspect, a third module may be provided, allowing for multiple time-of-flight ranging measurements to be taken between the modules from differing locations, such that successive bilateration may be used to compute the modules' relative physical positions with respect to each other.

According to yet another aspect, multiple digital transceiver modules may be arrayed, allowing for multiple time-of-flight measurements to be taken, such that trilateration may be used to compute their relative physical positions with respect to each other.

In a fifth aspect, certain modules may be uniquely coded to each other, allowing for the grouping and assignment of modules such that ranging and communication operations may be confined to units sharing a given code mating.

In another aspect, when multiple modules have determined their positions relative to one another, the relative positions of the modules may be registered against an external fixed coordinate system, as determined by a GPS or otherwise derived physical positioning of one or more of the modules.

In another aspect, multiple modules may be interconnected via a wireless mesh network protocol, allowing a message to be transmitted from a first module to another which is not directly reachable by the first, with the message being relayed by intervening modules along a workable path to the target.

In another, optional aspect, one or more of the digital transceiver modules may be fitted with diversity antennas, in order that a single module may make separate time-of-flight ranging measurements to a given target module from each antenna.

In another aspect, a motion-sensitive digital transceiver module may be moved during the taking of ranging measurements against a target, and may track its motion by way of reference to an attached or embedded digital accelerometer, allowing multiple discrete position fixes to be made from separate physical stations. In the context of this specification, the term “station” refers to a physical location, as may be defined by a given point in a three-space coordinate system.

In a further aspect, a digital transceiver module may be moved in a sweep with intermittent stops while it is taking multiple ranging measurements against a target. During the sweep dense clusters of ranging measurements will be produced at the point of intermittent stops allowing these dense clusters to be translated to separate physical stations.

In yet another aspect, a digital transceiver module may be capable of tracking its current status with respect to localization requests, such that when it has not received a localization request for a pre-determined period of time, it will transition into a “lost” state pending re-establishment of ranging telemetry with other modules. While in the “lost” state, the module may further transition into a low-power quiescent state, wherein it may passively monitor the inter-modular frequency range for any traffic from other modules which may enter its reception horizon. Upon receiving a suitably encoded ranging request, the passive module may then actively re-engage in localization activities.

In another aspect, a motion-sensitive digital transceiver module may be capable of tracking its current status with respect to its motion between successive position fixes, such that when it has been successfully localized with respect to neighbors, and has not yet registered any movement of its own position via accelerometer measurements, the module may enter a quiescent state, in order to conserve bandwidth and power supply energy pending any movement or external ranging request operations from neighboring modules.

In yet another aspect, the digital transceiver modules may be provided in the form of an interface module or card, which may be connected to a larger host platform such as a hand-held portable computing device, smart phone or portable computer, in order to provide ranging and lateration capabilities to the host device.

In another aspect, the circuitry of the digital transceiver modules may be fully integrated and built into that of a larger host platform, so as to provide ranging and lateration capabilities to the resulting device.

In another aspect, the digital transceiver module may communicate with the processor of the host platform via a suitable digital data transmission medium, such as IEEE 802.11, universal serial bus, an electronic interface such as a docking connector, or audio frequency modulation/demodulation techniques.

In another variant aspect, any host platforms integrated to the digital transceiver modules may be themselves connected to a larger external digital communication network, in order to allow these systems to communicate transceiver module-derived location information amongst themselves.

In another variant aspect, useful when the digital transceiver modules are themselves configured as nodes within a mesh network implementation, the mesh network itself may be used as a backup communications medium for transceiver-derived location information in the event of unavailability of the host system's larger external digital communications network.

In yet another optional aspect, there may be provided a central information storage system connected to the larger external digital communications network, such that the central information storage system may provide a remotely-accessible facility for the storage, indexing, and retrieval of object identification, ranging and location information derived from the digital transceiver module's operations.

In another aspect, the circuitry of the digital transceiver modules may be provided in the form of an attachable location tag which may be affixed or enclosed in an object, or worn by an operator or other person, in order to render the tag-carrying object or person externally range-able and directionally locatable.

According to one optional aspect, a configured grouping of digital transceiver modules may periodically and automatically conduct ranging operations between themselves, and compare their relative physical positioning with a pre-defined acceptable localization tolerance, such that in the event one module is at any time positioned outside the tolerable arena of freedom of movement, a location fix may be generated.

In another aspect of the system, a single out of contact or “lost” digital transceiver module monitor for request-for-ranging packets, such that upon the reception of one of these requests, the ungrouped module may re-engage with other transceiver modules within signal range, which may invoke their ranging and lateration processes against it, and thus determine the relative whereabouts of the orphaned unit.

In yet another optional aspect, upon the successful acquisition, ranging, and location of a lost module, one of the acquiring modules may signal on an attached digital network the location of the re-discovered module; by transmitting such information across the attached network to the central computing system for storage and indexing in the central data storage repository, where a second, informatory message may be composed and transmitted to the bonded object's owner.

In another optional aspect, the modules may be configured with a location tolerance, such that a module which has moved beyond a given relative location with respect to another may trigger the transmission of a message signaling the out-of-bounds condition. Similarly, by the use of multiple modules, an arbitrarily-shaped physical perimeter may be defined and monitored for boundary exceptions.

In yet another optional aspect, the modules may be configured with a location tolerance, such that a module which has moved crossing the default or arbitrarily shaped geofence may trigger the transmission of a message signaling the out-of-bounds condition. Similarly, by the use of multiple modules, an arbitrarily-shaped physical perimeter may be defined and monitored for boundary exceptions.

The foregoing summarizes the principal features of the invention and some of its optional aspects. The invention may be further understood by the description of the preferred embodiments, in conjunction with the drawings, which now follow.

Wherever ranges of values are referenced within this specification, sub-ranges therein are intended to be included within the scope of the invention unless otherwise indicated. Where characteristics are attributed to one or another variant of the invention, unless otherwise indicated, such characteristics are intended to apply to all other variants of the invention where such characteristics are appropriate or compatible with such other variants.

In accordance with another embodiment, the invention provides a method. The method involves performing a first time-of-flight ranging operation between first and second digital transceiver modules to produce first information on the distance between the first and second digital transceiver modules. The first digital transceiver module is at a first location. A second time-of-flight ranging operation between the first and second digital transceiver modules is performed to produce second information on the distance between the first and second digital transceiver modules. For this operation the first digital transceiver module is at a second location at a predetermined displacement from the first location. A third time-of-flight ranging operation is performed between the second digital transceiver module and a third digital transceiver module to produce third information on the distance between the first and second digital transceiver modules. The position of the third digital transceiver module relative to the first digital transceiver module is determined from the first, second and third information and the predetermined displacement.

In accordance with another embodiment, the invention provides a method. The method involves performing a first time-of-flight ranging operation between first and second digital transceiver modules to produce first information on the distance between the first and second digital transceiver modules. At a first location, a third digital transceiver module performs a second time-of-flight ranging operation by communicating with the first digital transceiver module to produce second information on the distance between the first and third digital transceiver modules. At a second location at a predetermined displacement from the first location, the third digital transceiver module performs a third time-of-flight ranging operation by communicating with the first digital transceiver module to produce third information on the distance between the first and third digital transceiver modules. The position of at least one of the first and second digital transceiver modules relative to the third digital transceiver module is determined from the first, second, and third information and the predetermined displacement.

Reference will now be made to the accompanying drawings.

### BRIEF DESCRIPTION OF THE DRAWINGS

Further features and advantages will become apparent from the following detailed description, taken in combination with the appended drawings.

FIG. 1 is a high-level block diagram of the common architecture of the digital transceiver modules according to one embodiment.

FIG. 2 shows a ranging probe packet being sent between two digital transceiver modules, with the receiving module replying back with a suitably encoded echo packet.

FIG. 3 shows the first stage of a typical bilateration operation, where two digital transceiver modules are collaborating in order to determine their inter-modular distance.

FIG. 4 shows the second stage of a successive bilateration operation, where two digital transceiver modules are collaborating in order to determine their relative positioning with respect to a third target unit.

FIG. 5 shows a trilateration operation, wherein one of the two digital transceiver modules has performed a second ranging operation from a different position, in order to remove any ambiguity in the solution of the position of the target unit.

FIG. 6 depicts the digital transceiver module of FIG. 1 in the form of a small accessory component which may be attached to the housing of a hosting portable electronic device.

FIG. 7 depicts the digital transceiver module accessory component of FIG. 6 making a data connection to the hosting portable device via an audio signal jack.

FIGS. 8 and 8A show an accelerometer-equipped digital transceiver module performing multiple ranging operations from discrete stations along a baseline path of motion.

FIG. 9 shows a distributed object tracking system with a centralized location registration, in accordance with another embodiment.

FIG. 10 provides a state transition diagram of a digital transceiver module's localization activities.

FIG. 11 provides a state transition diagram of a digital transceiver module which has become disengaged from location monitoring activity.

FIG. 12 is flow chart of a method of determining the position of a digital transceiver module, in accordance with an embodiment.

FIG. 13 is a block diagram of another exemplary digital transceiver module for the accurate relative positional localization and tracking of articles in the system of FIG. 9.

It will be noted that throughout the appended drawings, like features are identified by like reference numerals.

### DETAILED DESCRIPTION OF THE PREFERRED EMBODIMENTS

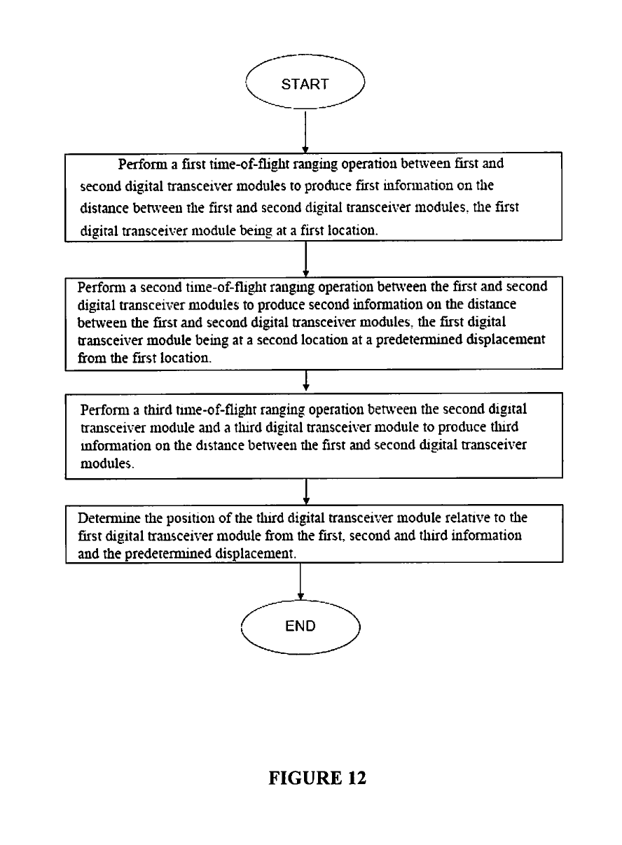

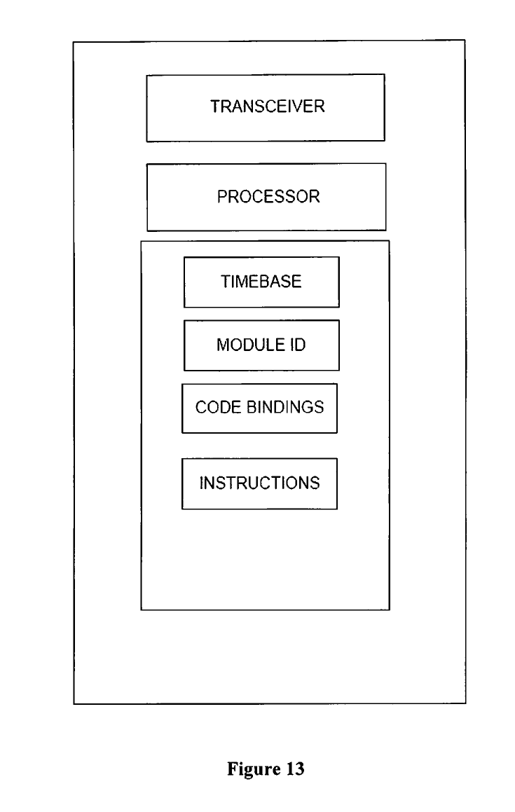

A method in which digital transceiver modules in a network communicate with each other to provide location monitoring will be described with reference to FIG. 12. At step 100, a first time-of-flight ranging operation is performed between first and second digital transceiver modules to produce first information on the distance between the first and second digital transceiver modules. At this step, the first digital transceiver module is at a first location. At step 101, a second time-of-flight ranging operation between the first and second digital transceiver modules is performed to produce second information on the distance between the first and second digital transceiver modules. At this step, the first digital transceiver module is at a second location with the second location being at predetermined displacement from the first location. At step 102, a third time-of-flight ranging operation is performed between the second digital transceiver module and a third digital transceiver module to produce third information on the distance between the second and third digital transceiver modules. At step 103, the position of the third digital transceiver module relative to the first digital transceiver module is determined from the first, second, and third information and the predetermined displacement.

There are a number of ways in which the time-of-flight ranging operations can be performed and in which information is transmitted between the modules. In an exemplary case, the first digital transceiver module performs the first and second time-of-flight measurements by communicating with the second digital module, and one of the second and third digital transceiver modules perform the third time-of-flight ranging operation and sends the information on the distance between the second and third digital transceiver modules to the first digital transceiver module. The first digital transceiver module then determines the position of the second and/or third digital transceiver module relative to the first digital transceiver module.

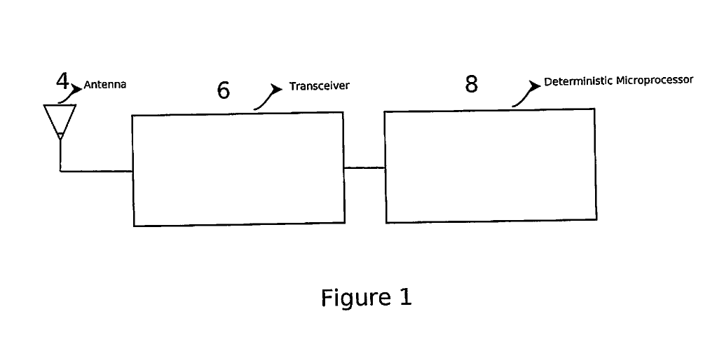

Further details of how the above method can be implemented in a network will now be described with reference to FIGS. 1 to 5.

As shown in FIG. 1, a digital radio frequency transceiver module is provided, comprising at least one antenna 4, a transceiver block 6 comprising a digital wireless transmitter and receiver, and a deterministic microprocessor 8.

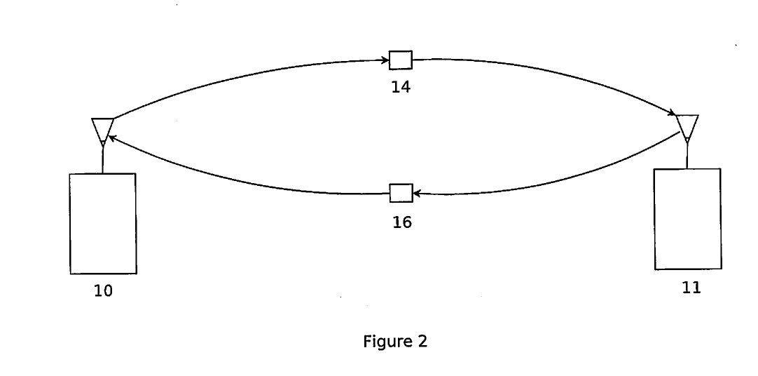

Turning to FIG. 2, and again referencing the transceiver internal block diagram of FIG. 1, a first transceiver module 10 is provided, which module's microprocessor unit 8 may execute a time-deterministic sequence of stored instruction codes in order to formulate and broadcast a uniquely identified digitally encoded “probe” record packet 14 via the transceiver 6 to radiate outwardly from antenna 4 on a pre-defined radio frequency range. At that point, the microprocessor 8 of module 10 may execute a sequence of stored instruction codes in order to begin marking time from the instant of the packet's transmission, and monitor the pre-defined radio frequency range for incoming packets which are identified with the original unique record identifier or a hash or repeatable transformation thereon.

Continuing with FIG. 2, a second digital transceiver module 11 is provided, which second module's microprocessor unit 8 may execute a time-deterministic sequence of stored instruction codes which cause the attached digital transceiver 6 to monitor signals in the pre-defined radio frequency range for the arrival of the uniquely identified digital probe packet 14. Upon packet reception and successful decoding, the microprocessor unit 8 of module 11 may execute a time-deterministic sequence of stored instruction codes in order to formulate and transmit a second “echo” answering packet 16 bearing the original record identifier or a hash or repeatable transformation thereon, for reception by the first transceiver module 10.

Upon reception of an incoming echo packet 16, the first digital transceiver module's microprocessor may execute a time-deterministic sequence of stored instruction codes in order to decode of the received packet and compare the packet's identifier to that of the transmitted probe packet 14. Should the identifier of the received packet 16 match that expected, the microprocessor 8 of the first digital transceiver module 10 may execute a time-deterministic sequence of stored instruction codes in order to record the time of reception and successful decoding of the echo packet, and calculate the total elapsed time between the emission of the original probe packet 14 and the reception and processing of the echo packet 16.

The microprocessor 8 of the first digital transceiver module 10 may then execute a further series of stored instruction codes in order to calculate the total round-trip radio propagation delay time of the probe packet 14 and echo packet 16, by subtracting from the total elapsed time the known deterministic time intervals required to execute; (1) the microprocessor instruction code sequences for the far-end probe packet reception and decoding, and echo packet preparation at the corresponding second module, and (2) the microprocessor instruction code sequences retired locally to decode and identify the received echo packet. The microprocessor 8 of the first transceiver module 10 may then execute another series of stored instruction codes in order calculate the total round-trip distance, by multiplying the elapsed total radio round-trip propagation time by the signal propagation velocity. Finally for the ranging calculation, microprocessor 8 may execute a series of stored instruction codes to divide the total round trip distance in half to obtain a representation of the linear distance 18 between the two corresponding first and second digital transceiver modules 10 and 11.

The microprocessor 8 is described above as being capable of time-deterministic operations for accounting for: (1) the microprocessor instruction code sequences for the far-end probe packet reception and decoding, and echo packet preparation at the corresponding second module, and (2) the microprocessor instruction code sequences retired locally to decode and identify the received echo packet. More generally, the processor 8 is any suitable processor capable of accounting in delays other than the time-of-flight of transmissions between modules, and can be implemented in hardware, firmware or as a dedicated circuit, for example.

According to the present disclosure, when multiple discrete distance measurements are made between digital transceiver modules, the fixing of relative inter-modular positions is possible.

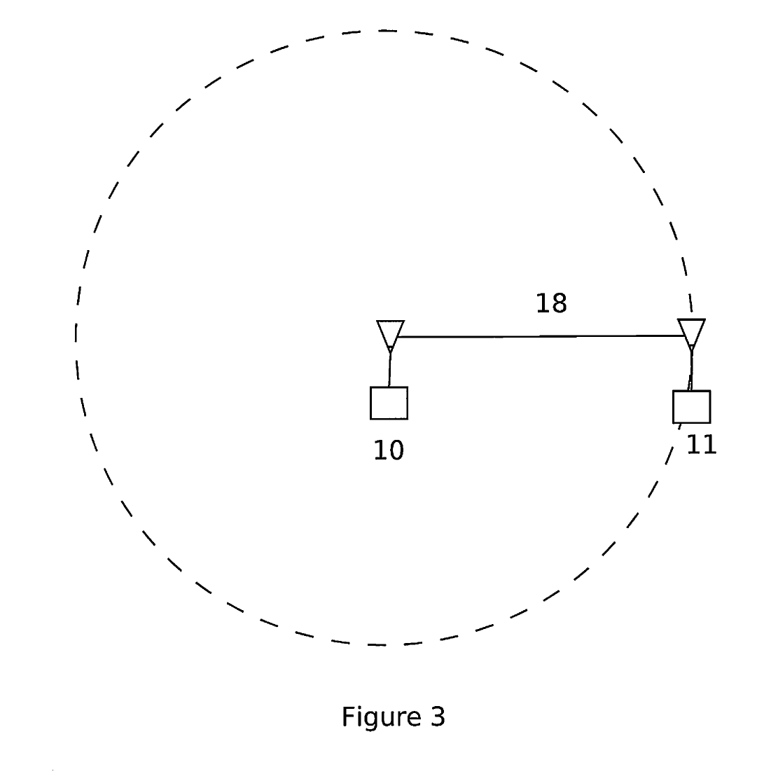

As shown in FIG. 3, and again with reference to the internal transceiver block diagram of FIG. 1, the time-of-flight ranging operation conducted by digital transceiver units 10 and 11 allows the microprocessor 8 of units 10 and 11 to compute the relative linear distance between their physical positions as a line segment 18. The actual two dimensional position of unit 11 with respect to unit 10 may thus be anywhere along the perimeter of a circle with radius length 18, described around unit 10.

According to present disclosure, the first digital transceiver unit 10 may be provided in the form of an interface card or fully integrated and embedded circuitry of a larger hand-held or portable computing device such as a smart phone, Personal Digital Assistant, or portable computer system, and the second digital transceiver unit 11 may be provided in the form of a wearable electronic tag worn by the system operator, for example on a belt or otherwise attached to clothing. The transceiver unit 10 may then be linked to unit 11 via the registration of their unique identifiers in a grouping code list, allowing the two units to discriminate their own transmissions, and those of any other registered code-mates, from those of other units which are members of a differing group.

In this application, the inter-modular distance between units 10 and 11 would represent the distance between the digital transceiver-equipped hand-held or portable computing device and the likewise equipped wearable tag at the instant of completion of the time-of-flight ranging operation between the two units.

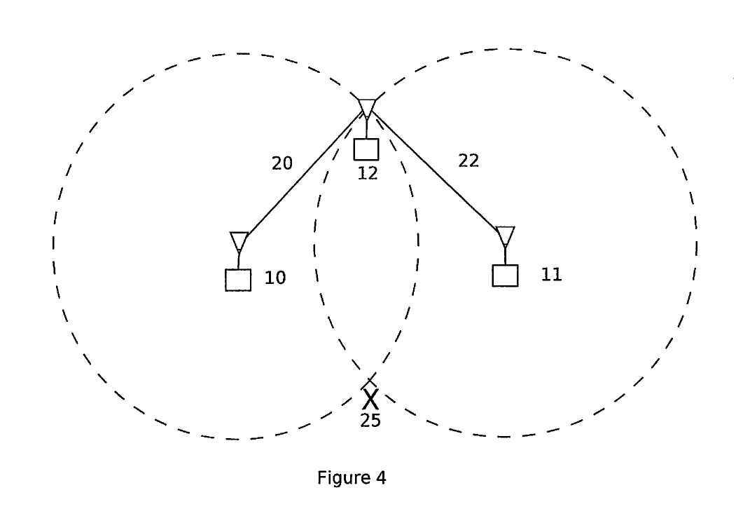

In FIG. 4, the two original digital transceiver units 10 and 11 are shown collaborating with a third target unit 12, in order to establish the relative positions of the three machines, in this case to range and localize the third target unit 12. The time-of-flight ranging operation is here conducted between digital transceiver unit 10 and target unit 12, which allows the microprocessor 8 of unit 10 and target unit 12 to compute the relative linear distance between their physical positions as a line segment 20, and thus establish a circle of potential unit 12 positions around unit 10 along the circle's perimeter at radius length 20. A second ranging operation is conducted between digital transceiver unit 11 and target unit 12, which allows the microprocessor 8 of unit 11 and target unit 12 to compute the relative linear distance between their physical positions as a line segment 22, and thus establish a second circle of potential target unit 12 positions around unit 11 along the circle's perimeter at radius length 22.

Once the length of the inter-modular radii 20 and 22 has been determined, the microprocessor 8 of any of the digital transceiver units may execute a series of stored instruction codes in order to project the perimeter points of the two ranging-derived position circles, thus determining at which points the two circles will intersect each other and effecting a bilateration operation.

In the case when the three digital transceiver units are physically arrayed in a linear or substantially linear manner, there will be a single point of intersection or a relatively small area of potential intersection between the ranging-derived position circles, and the position of target unit 12 will thus be considered well-established. At this point, the relative position of units 10, 11, and 12 may be presented on the display or otherwise annunciated by any digital transceiver module-equipped hand-held or portable computing device.

In the alternative case when the three digital transceiver units are not physically arrayed in a linear or substantially linear manner, their relative positions will describe a triangular configuration, as shown in FIG. 4. In these cases there will be an ambiguous pair of possible points of intersection between the ranging-derived position circles, one at the actual position of target unit 12, and another incorrect solution 25. For some applications, for example where the operator has clear line-of-site to the two potential target unit positions, such an ambiguous pair of potential positions for target unit 12 may be considered sufficiently well-established, and the relative positions of units 10 and 11 may be presented on the display or otherwise annunciated by any unit-attached hand-held or portable computing device, along with the two solutions for unit 12 and false location 25.

Should the ambiguous solution of two potential points of location for target unit 12 with respect to ranging units 10 and 11 not be adequate, there is provided the possibility of resolving to a single point of solution by taking an additional ranging measurement. This additional operation may be conducted by repositioning the ranging units 10 and 11, repeating the bilateration procedure described previously and shown in FIG. 4, and presenting the new resultant positional solutions.

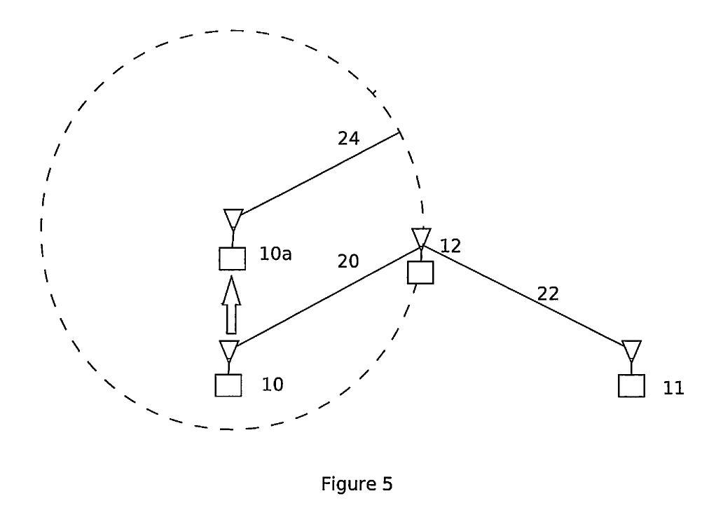

In FIG. 5 is shown a trilateration-based alternative embodiment in which another time-of-flight measurement is taken from a different position, allowing the relative position of target unit 12 to be resolved beyond the two-solution ambiguity arising from the three node bilateration described earlier. In this case, the module at position 10a conducts an additional ranging operation against module 12, defining a new radius 24 of potential locations. Since the perimeter of the circle described about module 10a only intersects one of the formerly ambiguous solutions of the original operation, the position of module 12 may be considered well defined. It should be noted that unit 10a may be a separate, fourth transceiver unit, or may simply be one of the original three units, having been provided with external position localization capability, for example via gyroscope or accelerometer measurement, or by reference to an outside positioning capability.

The above mechanism for measuring distances between modules involves round-trip time-of-flight measurements between two modules. In other implementation the modules are synchronized and the calculation of distance between the two modules involve a time of flight measurement of only one transmission between two modules.

In the case of additional digital transceiver units being introduced into the localization constellation, the ranging and localization sequences described earlier and shown in FIGS. 3, 4, and 5 may be repeated for and between the new units to establish additional inter-modular radii, calculate potential relative positioning circles and perform trilateration operations as described above. In this fashion a topological representation may be established defining the relative locations of the devices.

With the equipping of a digital receiver for inertial position tracking via accelerometer, it becomes possible for a single unit to serve as multiple virtual receivers. The inertially metered ranging module may then execute two separate ranging operations, one at the physical position 10, and a second after being moved to the different location 10a, along the upwardly-directed arrow appearing in FIG. 5. By referencing the on-board or connected accelerometer telemetry, unit 10 may determine its relative change in position from its original measurement position. By then undertaking another time-of-flight position with respect to target unit 12, the microprocessor 8 of digital transceiver unit 10 may execute stored instruction codes allowing it to correct for the difference between the original position 10 and the new position 10a, and perform a trilateration operation by computing the relative linear distance 24 between the physical positions of unit 10a and target unit 12, and establishing a new circle of potential target unit 12 positions around unit 10a along the circle's perimeter. Since this new circle of potential target unit positions relative to unit 10a will only intersect one of the previous bilateration solutions 12 and 25, the true position of unit 12 is thus known, and the other logical yet false solution is excluded.

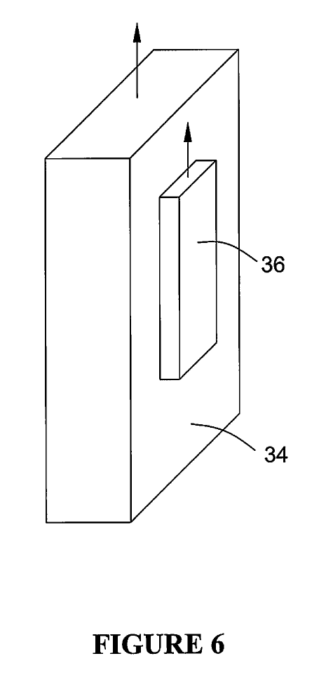

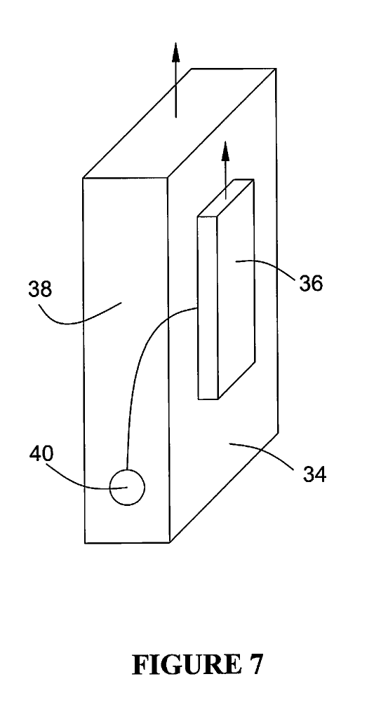

In a preferred embodiment, depicted in FIGS. 6 and 7, a single accelerometer-equipped module may serve to perform all ranging operations against a target module, and thus allow for accurate and unambiguous localization of the target with a minimum of hardware and communications complexity.

FIG. 6 shows a digital transceiver module 36 provided in the form of a mountable accessory device, which may be attached to the external housing of a hosting mobile device, as for example smart cellular telephone 34. The module may communicate with host device 34 according to the unit's native external interfacing capabilities, for example via a Universal Serial Bus interface, a low power 802.11B link, or IEEE-802.15.1 “Bluetooth” communication.

An alternative interfacing system for use with cellular telephones or other host devices lacking USB or 802.11 capability is shown in FIG. 7. In this variant, module 36 is connected to cellular telephone 34 through audio cable 38, which plugs into the phone's audio jack 40. Data transfer is then provided through the modulation and demodulation of audio tones across the audio channel.

Another alternative interfacing technique, not shown in the figures, may be effected by connecting the transceiver module directly to the host platform by way of the device's proprietary docking port connector.

Ideally, as an option to provisioning as an external accessory device, the digital transceiver module should be fully integrated with the circuitry of the portable host device to reduce cost of manufacture and distribution, and allow for the sharing of power supply, processing or input/output resources, and any application-relevant onboard instrumentation.

Continuing with FIGS. 6 and 7, if the host cellular telephone 34 is equipped with an onboard digital accelerometer, a software package for controlling and reading the device may be installed in the phone processor's memory. Alternately, a digital accelerometer may be provided as an integral component of digital transceiver module 36. A software package for the control and operation of the ranging system is also installed in the processor memory of cellular phone 34.

If the host cellular telephone 34 is equipped with GPS, GSM-based, or other self-localization functionality, a software package for registering and reconciling the digital transceiver module-derived relative positioning against this external reference coordinate system may be provided.

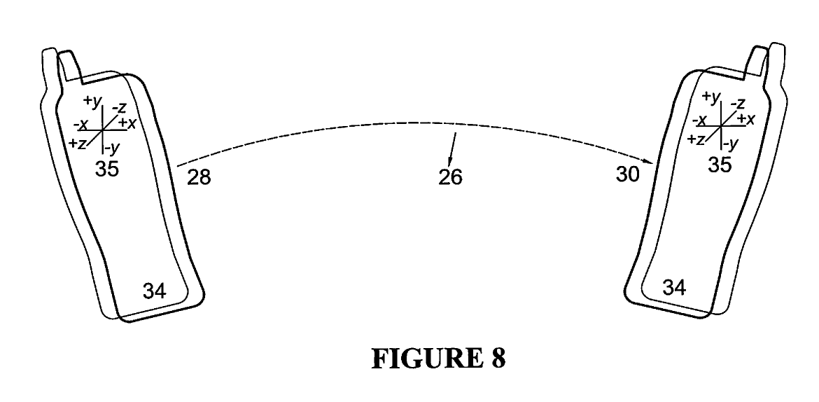

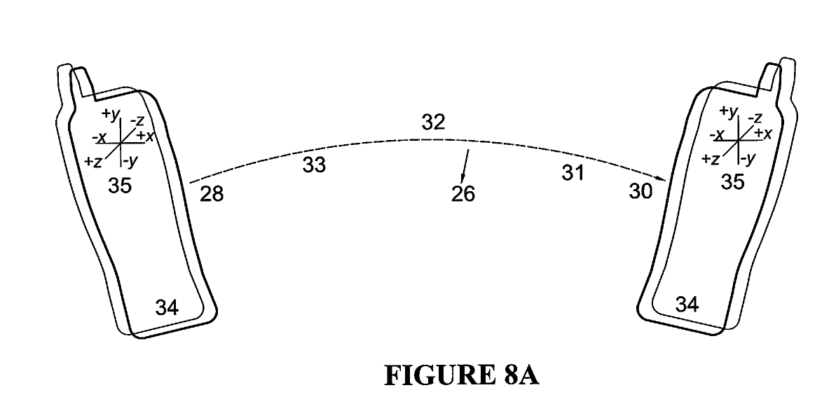

Operation of a representative accelerometer-equipped tracking module ranging system is depicted in FIG. 8. After the object to be tracked and located has been fitted with a digital transceiver module to serve as a target, the operator of cell phone 34 invokes the ranging system software to establish a baseline position track 26. The processor of cell phone 34 then executes a series of stored instruction codes which cause it to await a signal from the attached accelerometer indicating the device has begun motion.

As shown in FIG. 8, the operator then physically sweeps cell phone 34 along a simple, relatively linear track of motion 26, from initial position 28 to a different final position 30. The processor of the cell phone 34, upon receiving a start-of-motion signal from the accelerometer at position 28, executes a series of stored instructions to input the accelerometer's measurements during the device's motion to position 30, and from these measurements to compute the distance travelled between positions 28 and 30. The processor then executes a further set of stored instructions to determine the length of baseline track 26, dividing this length into four intermediary distances to calculate a trio of intermediary measurement positions 31, 32 and 33, as indicated in FIG. 8A. This calculation thus defines three ranging measurement stations at device positions 31, 32, and 33 respectively.

Continuing with FIG. 8A, the taking of the ranging measurements from outer stations 31 and 33, away from the end points themselves, serves two purposes: (1) taking the first ranging fix at station 31 allows sufficient time between the accelerometer detection of initial motion from end position 30 to allow for the ranging operation, and (2) the taking of the final ranging fix at position 33 mitigates against the system missing the final ranging fix opportunity in the case of a short operator back-sweep.

Once the positions of the ranging stations along baseline track 26 have been identified, and with the device now stationary at position 30, the processor of cell phone 34 then executes a series of stored instructions causing it to await a second start-of-motion signal from the accelerometer.

As depicted in FIG. 8A, to effect the ranging and localization of the target module, the operator sweeps the device back along the path of calibration from point 30 to point 28. The processor of cell phone 34, upon receiving the second start-of-motion signal from the accelerometer at position 30, executes a series of stored instructions to input the accelerometer's measurements during the device's motion to compute the approach to first intermediary station 31. Upon the determination that position 31 has been reached, the host telephone's processor executes a series of stored instructions to direct its associated digital transceiver module to conduct a first ranging operation against the target module from this station, and the accelerometer measurements are again read to determine the approach to second position 32. At station 32, a second time-of-flight ranging operation with the target module is performed, and then the processor executes a series of stored instructions to input the accelerometer's measurements during the device's motion to compute the approach to the third intermediary position 33. Upon the determination that station 33 has been reached, a final ranging operation is performed with the target module, and stored instructions may be executed in order to request and receive the computed convergence of the three ranging radii from the associated digital transceiver module, register and reconcile the module-derived measurements to any externally available reference coordinate system, and graphically or textually present a representation of the localization operation's result to the operator on the display of phone 34.

Alternately, the tracking module may operate autonomously, making intermittent ranging measurements to its target module or modules, and updating the host device with the latest localization results at periodic intervals, when circumstances change, or upon demand.

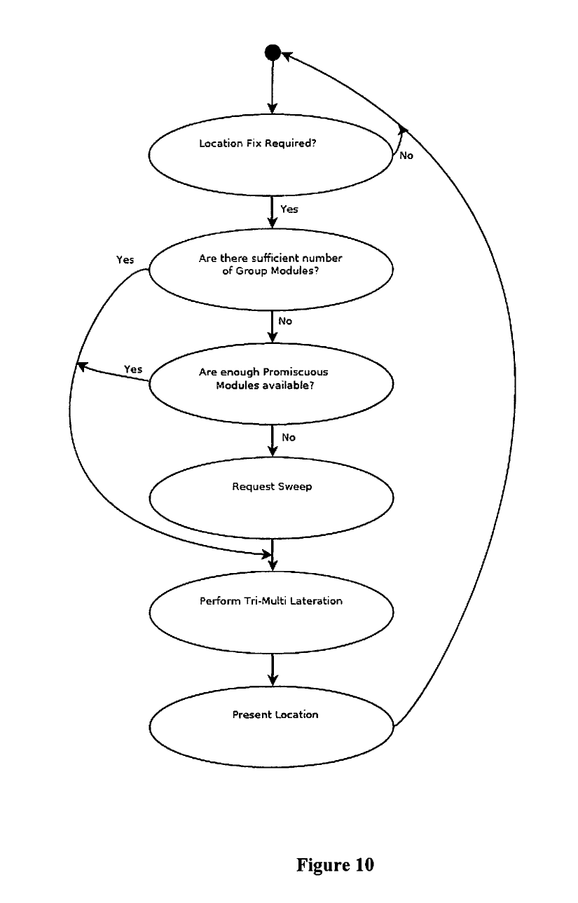

FIG. 10 depicts a state transition diagram and decision tree showing the hierarchy of possible inter-module localization approaches, where preference is first given to code-mated modules, followed by reachable promiscuous units, ultimately resorting to a single unit physical sweep in cases where insufficient collaborating modules exist for a successful localization cycle.

Range monitoring may also be provided, wherein operator alerts are given should a tracked object be unreachable via ranging telemetry, or if an object is found to have exceeded a predefined tolerance regarding location or position. In the latter case, any module may be configured with a location tolerance, such that when it has been determined that the tracked module has moved beyond a given position with respect to another reference module, the transmission of a message signalling the out-of-bounds condition may be effected. Similarly, given a physical layout of multiple modules, an arbitrarily-shaped physical perimeter may be defined and monitored for boundary exceptions.

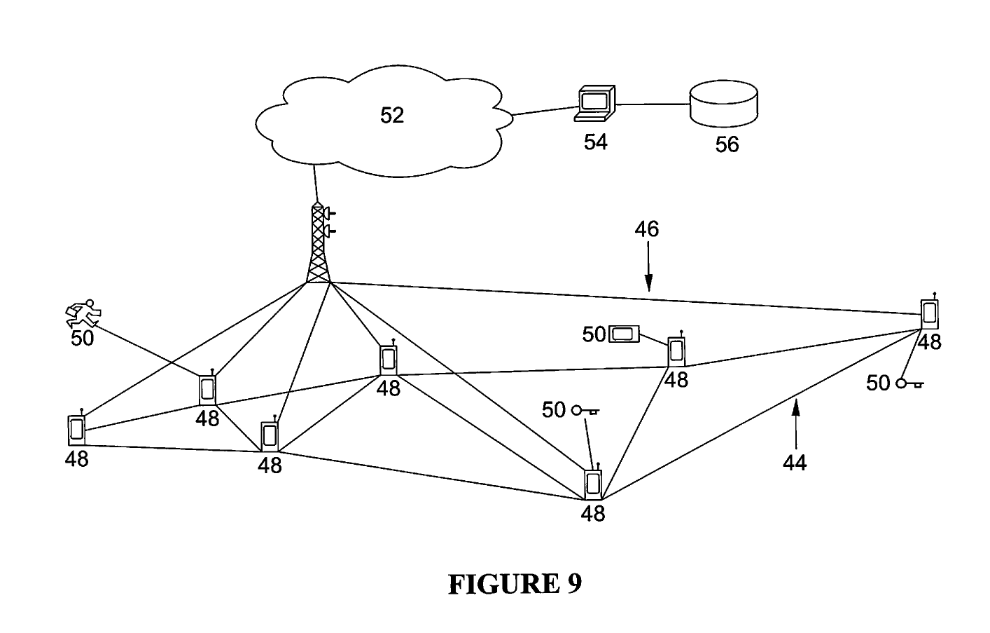

FIG. 9 shows a preferred embodiment, of a distributed object tracking system with a centralized location registration facility. For the purposes of localization and tracking, tagged objects 50 are fitted with digital transceiver modules as described above, to be tracked by a group of digital-transceiver equipped cellular telephones 48, as described above. The digital transceiver modules are interconnected by the application-specific wireless mesh network 44. Each object-tracking digital transceiver module is associated with connected cellular telephone 48, and the cellular telephones are enrolled and present on external digital cellular telephony network 46. Cellular network 46 is itself bridged to an Internet Protocol or other digital computer communications network 52. A centralized tracking service computer system 54 has access to a central data storage repository 56 in the form of a database management system, or DBMS.

The data repository 56 is organized into a storage schema composed of a tracked object database, a user profile database, a ranging devices database, and an object coordinates and tracking and availability status database.

In operation, each transceiver module-equipped cellular telephone 48 and object 50 to be tracked is serialized with a unique digital identification code and telephones and tracked objects are associated with each other via registration entries in repository 56. Users are also given unique digital identifiers and relationally associated with telephones 48 and tracked objects 50. Tracked objects, tracking telephones and users are also provided with status variables for the storage of their current system status and availability.

When any tracked object has been localized to a given position, the processor of the associated tracking telephone 48 may execute stored instruction sequences to compose and transmit a position fix message across wireless network 46 and digital communication network 52 to the attached tracking service computer system 54. Computer system 54 then stores the new circumstances of the located object into the repository 56 according to the application-specific storage and indexing schema in force. This upstream reporting of object locations over time allows computer system 54 to define and maintain an “evergreen” representation of any changes in the positions of the tracked objects.

In a variant approach, where upstream messaging to the computer system 54 is to be minimized, it is possible to only record the last known position of a given module in the central repository. In this case, a location update to the central repository would be issued when a module is initially registered, and subsequently only when it has been rediscovered after having entered the lost state. In order to avoid extremely stale positional fixes on modules which have not disassociated from their group over a considerable physical re-location, the responsible tracking telephone 48 may itself periodically determine and cache the positions of its code-mates, uploading such last known fix data to the central repository if, and only if, any mated modules become inaccessible.

If telemetry to a given tracked object's associated module has been lost, and therefore the object's location is unknown, the responsible tracking telephone 48 may report this situation, potentially including the object's last known positional fix, upstream to service computer system 54. The service computer may then register the lost state of the object in data repository 56.

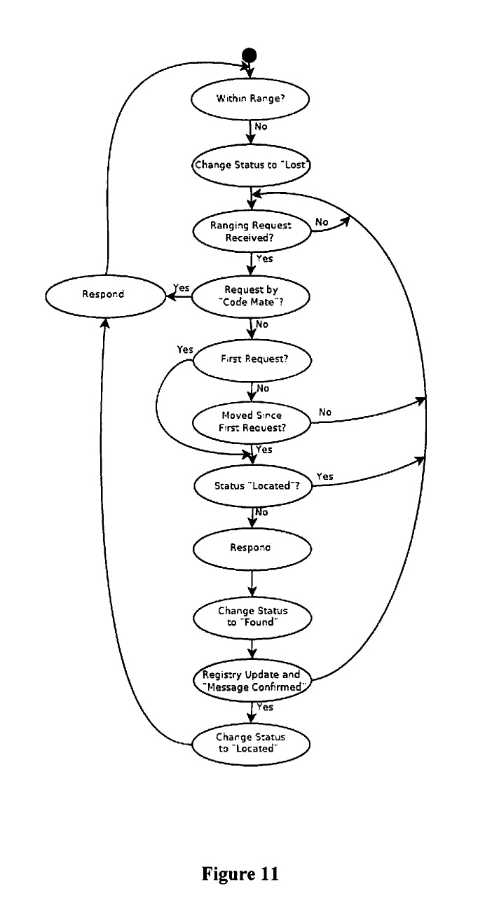

With reference to the exemplary module state transition diagram of FIG. 11, any module which has had a pre-defined time interval elapse without external ranging requests being received or its own requests answered may enter a power-conservation “lost” state, wherein the lost module's processor 8 executes a series of stored instructions which cause it to transition into a quiescent mode. In this quiescent mode, the module ceases to broadcast ranging requests, and passively monitors the inter-module frequency range for traffic from any other modules which may enter its reception range.

Upon reception of a ranging request from another module, the lost module may then originate a ranging request in order to re-establish localization for itself. Other promiscuous-mode modules which copy this request may then collaborate with the lost transceiver module and thereby establish a new position for the missing article.

Upon the reacquisition of the lost module to the overall localization network, the re-discovered module's processor 8 may then transition into a “found” state, where it then executes a series of stored instructions which cause it to compose and transmit a rediscovery confirmation packet. Upon receipt of the rediscovery confirmation packet, one of the collaborating host telephones may then report the rediscovery of the lost module, as well as its new position, upstream to service computer system 54, and the telephone's associated module then compose and transmit a rediscovery acknowledgement packet for broadcast back to the newly acquired module. Additionally, one of the collaborating host telephones may originate a message reporting the lost module's re-acquisition to the central repository system, which may then retrieve network addressing information and relay an appropriate informatory message to the re-discovered module owner's telephone, personal computer, or other system.

Upon receipt of the rediscovery acknowledgement packet, the previously lost module's processor may then execute a series of stored instructions which cause it to transition from the “located” state into a quiescent mode, where it adopts a low power state of operation, during which it will only respond to ranging requests from an appropriately identified code-mate such as the normal owner's cellular telephone.

Upon receiving an appropriately coded ranging request while in the “located” state, a quiescent transceiver module may then enter normal operational mode.

While in the “lost” state, to reduce overall message traffic and conserve energy pending reunification with its code-mates, a quiescent digital transceiver module may also suspend transmission of request-for-ranging requests while the accelerometer measurements show no further motion. Additionally, the transceiver module may signal the processor of any attached host device to undertake any appropriate operational sequence, such as suspending certain unnecessary operations and itself entering a power conservation state.

If motion is detected by a quiescent digital transceiver module's associated accelerometer during the quiescent mode, the module may then transition back to the “lost” state pending re-acquisition by other promiscuous-mode telephones. Upon successful localization, the acquiring telephones will thus upload new coordinates for the lost unit to central computer system 54, creating a record of the orphan's travels in storage repository 56.

The re-acquired article's position having then been encoded and transmitted upstream to service computer system 54, the service computer may then update the storage repository 56 with the object's new status and location, and issue a notification of the object's position to the originally associated tracking telephone or directly to the user by other means.

In the event that the larger host-connected wireless telephone network 46 is down or otherwise unavailable, and should the digital transceiver modules themselves be operating in a wireless mesh network configuration, the location fixes of any reacquired lost module may also be relayed from the acquiring module, between such suitably positioned intervening promiscuous modules in mesh network 44, in order to provide a backup means of notification of the lost module's location to a code-mated module. In this case, the module receiving the notification may then signal the attached cellular telephone's processor to present the notification information in a suitably formatted manner on the telephone's display. Should both the wireless telephone network 46 and the mesh network 44 not be capable of relaying a notification message, the notification information may be stored by the acquiring module for subsequent relay when communications capability is restored.

Referring to FIG. 14, shown is a block diagram of another exemplary digital transceiver module for the accurate relative positional localization and tracking of articles in the system of FIG. 9. The module has a digital radio frequency transceiver and an antenna coupled to the transceiver's radio frequency input and output signals. A deterministic microprocessor is coupled to the transceiver's data and control signals. The module also has a timebase for the measurement of elapsed intervals accessible to the microprocessor, an immutable and unique digitally stored module identification code, a programmable array of allowable module identification code bindings. The timebase is implemented as any suitable timer, for example. Software in the form of executable instruction codes provides for control of the radio frequency transceiver, the conduction of time-of-flight ranging operations against neighboring modules bearing allowable identification codes, and the computation of the relative positioning of the module with respect to such neighboring modules. With such devices in a system, a grouping of modules bearing a programmed identification code set may accurately determine the relative physical position of a group member module associated with a given article to be tracked.

### CONCLUSION

The foregoing has constituted a description of specific embodiments. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

I claim:

1. A system for the accurate relative positional localization and tracking of articles through time-of-flight ranging, wherein a plurality of digital transceiver modules are arrayed at arbitrary, discrete physical locations, and any of these modules being associated with articles to be tracked, said transceiver modules comprising:
(a) a digital radio frequency transceiver;
(b) an antenna coupled to the transceiver's radio frequency input and output signals;
(c) a deterministic microprocessor coupled to the transceiver's data and control signals;
(d) a timebase for the measurement of elapsed intervals accessible to the microprocessor;
(e) an immutable and unique digitally stored module identification code;
(f) a programmable array of allowable module identification code bindings; and
(g) software in the form of executable instruction codes providing for control of the radio frequency transceiver, the conduction of time-of-flight ranging operations against neighboring modules bearing allowable identification codes, and the computation of the relative positioning of the module with respect to such neighboring modules;
such that a grouping of modules bearing a programmed identification code set may accurately determine the relative physical position of a group member module associated with a given article to be tracked.

2. A method comprising:
performing a first time-of-flight ranging operation between first and second digital transceiver modules to produce first information on the distance between the first and second digital transceiver modules, the first digital transceiver module being at a first location;
performing a second time-of-flight ranging operation between the first and second digital transceiver modules to produce second information on the distance between the first and second digital transceiver modules, the first digital transceiver module being at a second location at a predetermined displacement from the first location;
performing a third time-of-flight ranging operation between the second digital transceiver module and a third digital transceiver module to produce third information on the distance between the first and second digital transceiver modules; and
determining the position of the third digital transceiver module relative to the first digital transceiver module from the first, second and third information and the predetermined displacement.

3. A method comprising:
performing a first time-of-flight ranging operation between a first and second digital transceiver modules to produce first information on the distance between the first and second digital transceiver modules;
at a first location, a third digital transceiver module performing a second time-of-flight ranging operation by communicating with the first digital transceiver module to produce second information on the distance between the first and third digital transceiver module;
at a second location at a predetermined displacement from the first location, the third digital transceiver module performing a third time-of-flight ranging operation by communicating with the first digital transceiver module to produce third information on the distance between the first and third digital transceiver modules; and
determining the position of at least one of the first and second digital transceiver modules relative to the third digital transceiver module from the first, second, and third information and the predetermined displacement.
